(19) United States
(12) Patent Application Publication
(10) Pub. No.: US 2016/0216795 A1
(43) Pub. Date: Jul. 28, 2016

(54) TOUCH SENSOR PANEL AND METHOD FOR MANUFACTURING SAME

(71) Applicant: Solomon Systech (Shenzhen) Limited, Shenzhen (CN)

(72) Inventor: Kam Tim Cheung, Hong Kong (HK)

(73) Assignee: Solomon Systech (Shenzhen) Limited

(21) Appl. No.: 14/603,379

(22) Filed: Jan. 23, 2015

(51) Int. Cl. G06F 3/044

(52) U.S. Cl. CPC G06F 3/044; G06F 2203/04112; G06F 2203/04103

(57) ABSTRACT

A touch sensor panel includes a first set and a second set of sensor elements patterned in a plurality of intersecting rows and columns. The first set of sensor elements are configured to be drive electrodes. The second set of sensor elements are configured to be sense electrodes. Each row includes at least one drive electrode from the first set. Each column includes at least one sense electrode from the second set. A method for manufacturing a touch sensor panel is also provided.

### FIELD OF THE PATENT APPLICATION

The present patent application generally relates to touch panel connection topologies and touch sensor controller design and more specifically to a touch sensor panel and a method for manufacturing such a touch sensor panel.

### BACKGROUND

Touch panels are widely employed as user input devices. These touch panels provide easy and user-friendly interface between electronic devices and human beings. People can use their fingers or styli to select and slide icons easily and effectively.

Portable devices are getting thinner and thinner. Every component is carefully designed. There have been numerous attempts to reduce the thickness of a touch panel, and it is necessary to make the touch sensor on a single layer of a substrate.

Electronic devices can be at portrait or at landscape orientation. A smartly designed touch panel controller possesses sufficient computing power and advanced configurations to support a wide variety of touch panels.

### SUMMARY

The present patent application is directed to a touch sensor panel. In one aspect, the touch sensor panel includes a first set and a second set of sensor elements patterned in a plurality of intersecting rows and columns. The first set of sensor elements are configured to be drive electrodes. The second set of sensor elements are configured to be sense electrodes. Each row includes at least one drive electrode from the first set. Each column includes at least one sense electrode from the second set.

The first set and a second set of sensor elements may be constructed from a single patterned layer of conductive material. Each row may include only one drive electrode while each column may include more than one sense electrode.

Each row may include more than one drive electrode. Each column may include only one sense electrode. Every k adjacent columns may include the same sense electrode, k being an integer greater than 1.

Each row may include more than one drive electrode and each column may include more than one sense electrode. Every two adjacent columns may include the same sense electrodes but different drive electrodes. Every n adjacent columns may include different sense electrodes forming a predetermined pattern, and the predetermined pattern may be repeated at least once among all the columns, n being an integer greater than 1. Within n adjacent columns that form the predetermined pattern, each row may include the same drive electrode. Within the n adjacent columns, the drive electrodes at the same row and adjacent two columns may be combined into one physical drive electrode.

In another aspect, the touch sensor panel includes a first set and a second set of sensor elements patterned in a plurality of intersecting rows and columns. The first set of sensor elements are configured to be drive electrodes. The second set of sensor elements are configured to be sense electrodes. Each row includes more than one drive electrode from the first set. Each column includes more than one sense electrode from the second set. The first set and a second set of sensor elements are constructed from a single patterned layer of conductive material. Every n adjacent columns include different sense electrodes forming a predetermined pattern, and the predetermined pattern is repeated at least once among all the columns, n being an integer greater than 1.

Within n adjacent columns that form the predetermined pattern, each row may include the same drive electrode while the drive electrodes at the same row and adjacent two columns may be combined into one physical drive electrode.

In yet another aspect, the present patent application provides a method for manufacturing a touch sensor panel. The method includes: patterning a first set and a second set of sensor elements in a plurality of intersecting rows and columns; configuring the first set of sensor elements to be drive electrodes; and configuring the second set of sensor elements to be sense electrodes. Each row includes at least one drive electrode from the first set. Each column includes at least one sense electrode from the second set.

The method may further include constructing the first set and a second set of sensor elements from a single patterned layer of conductive material. Each row may include only one drive electrode while each column may include more than one sense electrode.

Each row may include more than one drive electrode, each column may include only one sense electrode, and every k adjacent columns may include the same sense electrode, k being an integer greater than 1.

Each row may include more than one drive electrode and each column may include more than one sense electrode. Every two adjacent columns may include the same sense electrodes but different drive electrodes. Every n adjacent columns may include different sense electrodes forming a predetermined pattern, and the predetermined pattern may be repeated at least once among all the columns, n being an integer greater than 1. Within n adjacent columns that form the predetermined pattern, each row may include the same drive electrode. Within the n adjacent columns, the drive electrodes at the same row and adjacent two columns may be combined into one physical drive electrode.

### BRIEF DESCRIPTIONS OF THE DRAWINGS

FIG. 1 is a schematic diagram that illustrates a touch sensor panel.

FIG. 2 illustrates a touch sensor panel in accordance with an embodiment of the present patent application.

FIG. 3 illustrates a touch sensor panel in accordance with another embodiment of the present patent application.

FIG. 4 illustrates a touch sensor panel including drive and sense electrodes.

FIG. 5 illustrates a touch sensor panel in accordance with another embodiment of the present patent application.

FIG. 6 illustrates a touch sensor panel to be used in a smart phone.

FIG. 7 illustrates how the touch sensor panel in FIG. 6 is modified in accordance with another embodiment of the present patent application.

FIG. 8 illustrates how the touch sensor panel in FIG. 6 is modified in accordance with another embodiment of the present patent application.

FIG. 9 illustrates how the touch sensor panel in FIG. 6 is modified in accordance with another embodiment of the present patent application.

FIG. 10 illustrates how the touch sensor panel in FIG. 6 is modified in accordance with another embodiment of the present patent application.

FIG. 11 illustrates how the touch sensor panel in FIG. 6 is modified in accordance with another embodiment of the present patent application.

FIG. 12 illustrates how the touch sensor panel in FIG. 11 is modified in accordance with another embodiment of the present patent application.

FIG. 13 illustrates a touch sensor panel being connected to a microcontroller in accordance with an embodiment of the present patent application.

### DETAILED DESCRIPTION

Reference will now be made in detail to a preferred embodiment of the touch sensor panel and the method for manufacturing the same disclosed in the present patent application, examples of which are also provided in the following description. Exemplary embodiments of the touch sensor panel and the method for manufacturing the same disclosed in the present patent application are described in detail, although it will be apparent to those skilled in the relevant art that some features that are not particularly important to an understanding of the touch sensor panel and the method for manufacturing the same may not be shown for the sake of clarity.

Furthermore, it should be understood that the touch sensor panel and the method for manufacturing the same disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

FIG. 1 is a schematic diagram that illustrates a touch sensor panel 100. Referring to FIG. 1, the touch sensor panel includes a capacitive touch sensor pattern constructed from a single patterned layer of conductive material. The capacitive touch sensor pattern includes two sets of intersecting sensor elements wherein each sensor element in a first set intersects each sensor element in a second set. One set of sensor elements may be used as transmit electrodes or drive electrodes, the other set of sensor elements may be used as receive electrodes or sense electrodes in a mutual capacitance sensing system. The first set and second set of sensor elements are patterned in a plurality of rows and columns. In this embodiment, there are eighteen rows and ten columns. Each column has nineteen connecting traces 102 and bonding pads 104. There are totally 190 connecting traces and bonding pads.

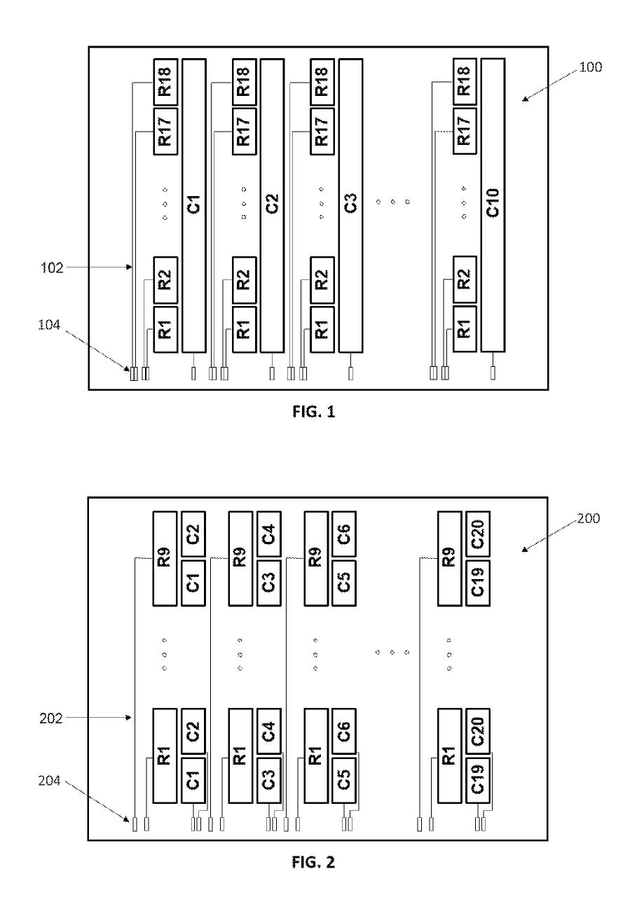

FIG. 2 illustrates a touch sensor panel 200 in accordance with an embodiment of the present patent application. Referring to FIG. 2, in the touch sensor panel 200, each column has two column electrodes, while each row has one row electrode. The left most column has column electrodes C1 and C2. The number of row electrodes is reduced to half of that required in the touch sensor panel 100. Each column has eleven connecting traces 202 and bonding pads 204. There are totally 110 connecting traces 202 and bonding pads 204. The number of bonding pads is only 58% of that of the touch sensor panel 100.

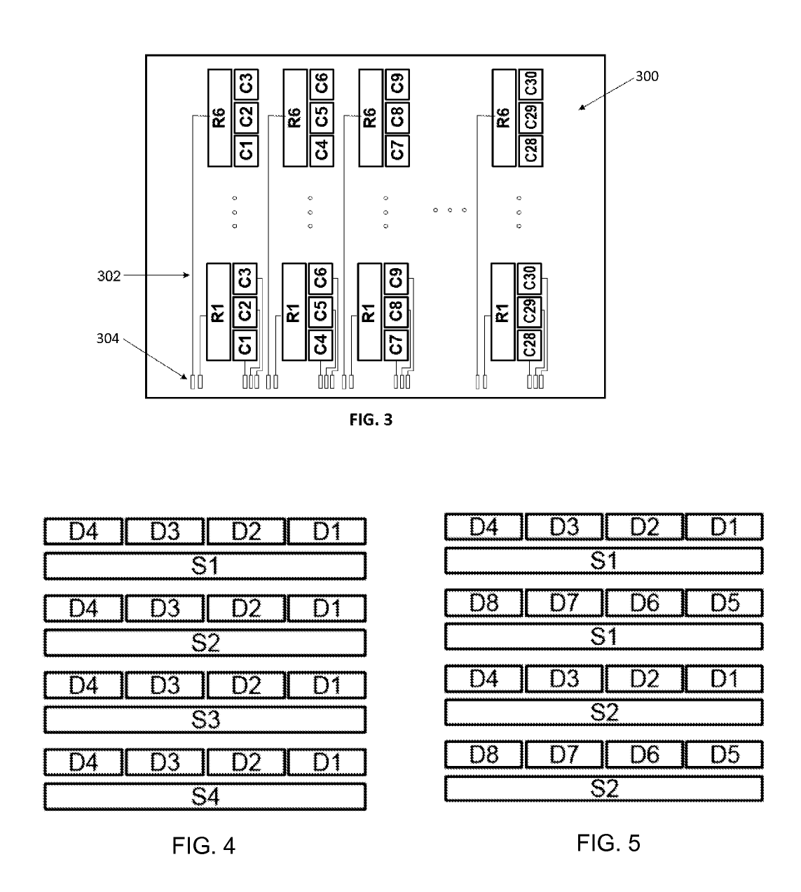

FIG. 3 illustrates a touch sensor panel 300 in accordance with another embodiment of the present patent application. Each column has three column electrodes. Referring to FIG. 3, the left most column has column electrodes C1 and C2 and C3. The number of row electrodes is reduced to one third of that required in the touch sensor panel 100. Each column has nine connecting traces 302 and bonding pads 304. There are totally 90 connecting traces 302 and bonding pads 304. The number of bonding pads 304 is only 47% of that of the touch sensor panel 100.

In other words, implementing n column electrodes at each column reduces the number of row electrodes to 1/n of that required in the touch sensor panel 100. The total number of bonding pads is equal to [(number of rows/n)+n] times the number of columns. As a result, the number of bonding pads is greatly reduced. The production yield of attaching flexible printed circuit board onto the touch sensor panel is therefore improved.

It is noted that in the above embodiments, the column electrodes may be sense electrodes, and the row electrodes may be drive electrodes.

FIG. 4 illustrates a touch sensor panel including drive and sense electrodes. Referring to FIG. 4, each row is driven by a drive channel. Each column is connected to a sense channel. There are totally four drive channels D1-D4 and four sense channels S1-S4 in this example

Most of the smart phones are at a portrait orientation. The touch sensor panels used in smart phones require more drive channels than sense channels. On the other hand, most of the tablets are at a landscape orientation. The touch sensor panels used in tablets require more sense channels than drive channels.

FIG. 5 illustrates a touch sensor panel in accordance with another embodiment of the present patent application. Referring to FIG. 5, the left most column is identical to that illustrated in FIG. 4. The adjacent column can make use of the same sense channel S1 when the rows are driven by different drive channels D5-D8. The right most column can also make use of the second sense channel S2. Hence, only two sense channels S1 and S2 are used for four columns.

It is noted that in this embodiment, each row includes more than one drive electrode (D4 and D8), each column includes only one sense electrode (S1 or S2), and every k adjacent columns include the same sense electrode (S1 or S2), k being an integer greater than 1 (k=2 in this embodiment).

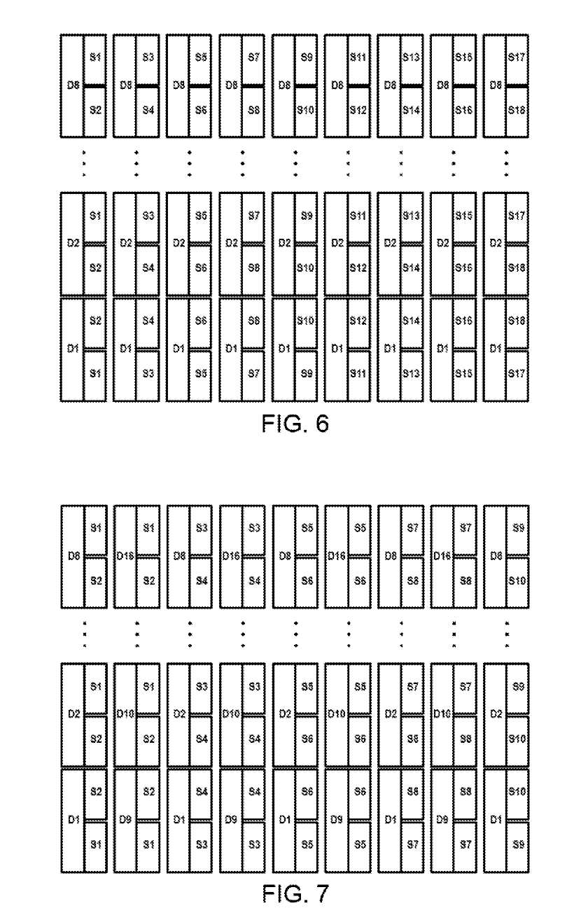

FIG. 6 illustrates a touch sensor panel to be used in a smart phone. Referring to FIG. 6, there are eight columns and a plurality of rows. Each row is driven by a drive channel, such as one of drive channels D1-D8. Each column is connected to two sense channels, such as two of sense channels S1-S18. There are totally eight drive channels D1-D8 and eighteen sense channels S1-S18 used in this example

FIG. 7 illustrates how the touch sensor panel in FIG. 6 is modified in accordance with another embodiment of the present patent application. Referring to FIG. 7, counting from the left, the first column is connected to the first and the second sense channel S1 and S2, the rows are driven by drive channels D1 to D8. The second column is also connected to the first and the second sense channel S1 and S2, but the rows are driven by drive channels D9 to D16. In this method, only ten sense channels S1-S10 are required. It is noted that in FIG. 6, ten sense channels are required.

It is noted that in this embodiment, each row includes more than one drive electrode (D1 and D9) while each column includes more than one sense electrode (for example S1 and S2). Every two adjacent columns, for example, the first and second columns from the left, include the same sense electrodes (S1 and S2) but different drive electrodes (D1-D8 and D9-D16).

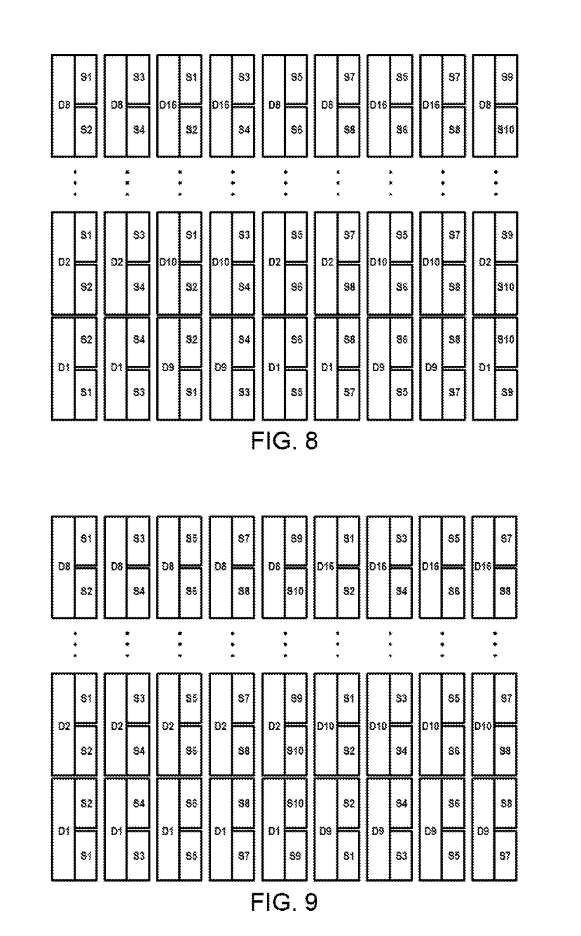

FIG. 8 illustrates how the touch sensor panel in FIG. 6 is modified in accordance with another embodiment of the present patent application. Referring to FIG. 8, counting from the left, the first column is connected to the first and the second sense channel S1 and S2, the second column is connected to the third and fourth sense channel S3 and S4, while these two columns are driven by drive channels D1 to D8. The third column is also connected to the first and the second sense channel S1 and S2, the fourth column is also connected to the third and the fourth sense channel S3 and S4, where these two columns are driven by drive channels D9 to D16. In this embodiment, only ten sense channels are required.

It is noted that in this embodiment, every n adjacent columns include different sense electrodes (S1, S2; S3, S4) forming a predetermined pattern, and the predetermined pattern is repeated at least once among all the columns, n being an integer greater than 1 (n=2 in this embodiment). Within n adjacent columns that form the predetermined pattern, each row includes the same drive electrode (D1 for example).

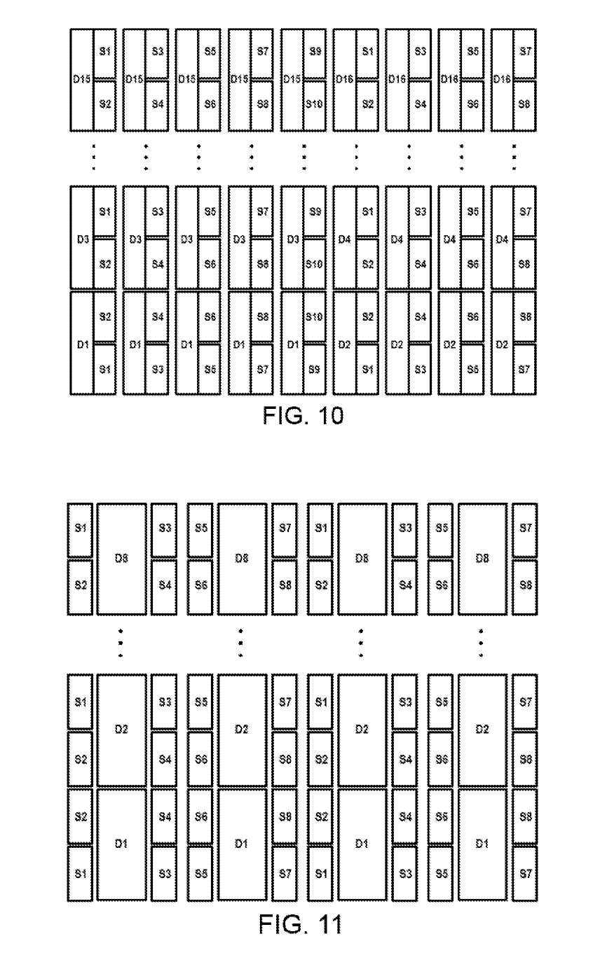

FIG. 9 illustrates how the touch sensor panel in FIG. 6 is modified in accordance with another embodiment of the present patent application. Referring to FIG. 9, counting from the left, the first column is connected to the first and the second sense channel S1 and S2, the second column is connected to the third and fourth sense channel S3 and S4, and so until the fifth column, while these five columns are driven by drive channels D1 to D8. The sixth column is connected to the first and the second sense channel S1 and S2, the seventh column is also connected to the third and the fourth sense channel S3 and S4, and so on until the last column, while these four columns are driven by drive channels D9 to D16. In this embodiment, only ten sense channels are required.

It is noted that in this embodiment, every n adjacent columns include different sense electrodes (S1, S2; S3, S4; S5, S6; S7, S8; S9, S10) forming a predetermined pattern, and the predetermined pattern is repeated at least once among all the columns, n being an integer greater than 1 (n=5 in this embodiment). Within n adjacent columns that form the predetermined pattern, each row includes the same drive electrode (D1 or D2 for example).

FIG. 10 illustrates how the touch sensor panel in FIG. 6 is modified in accordance with another embodiment of the present patent application. Referring to FIG. 10, counting from the left, the first column is connected to the first and the second sense channel S1 and S2, the second column is connected to the third and fourth sense channel S3 and S4, and so until the fifth column, while the lowest row of these five columns is driven by the first drive channel D1, and the adjacent upper row is driven by the third drive channel D3. The sixth column is connected to the first and the second sense channel S1 and S2, the seventh column is also connected to the third and the fourth sense channel S3 and S4, and so on until the last column, while the lowest row of these four columns is driven by the second channel D2, and the adjacent upper row is driven by the fourth drive channel D4. In this embodiment, only ten sense channels are required.

It is noted that in this embodiment, every n adjacent columns include different sense electrodes (S1, S2; S3, S4; S5, S6; S7, S8; S9, S10) forming a predetermined pattern, and the predetermined pattern is repeated at least once among all the columns, n being an integer greater than 1 (n=5 in this embodiment). Within n adjacent columns that form the predetermined pattern, each row includes the same drive electrode (D1 or D3 for example).

FIG. 11 illustrates how the touch sensor panel in FIG. 6 is modified in accordance with another embodiment of the present patent application. Referring to FIG. 11, counting from the left, the first column is connected to the first, the second, the third, and the fourth sense channel S1, S2, S3 and S4. It is physically one column, but logically two columns. The second column is connected to the fifth, the sixth, the seventh, and eighth sense channel S5, S6, S7 and S8. It is physically the second column, but it is logically the third and the fourth columns, and so on until the last column. In this embodiment, the number of drive lines and bonding pads for drive lines are reduced to half of that required in FIG. 10.

It is noted that in this embodiment, within n adjacent columns, the drive electrodes at the same row and adjacent two columns are combined into one physical drive electrode (D1 for example).

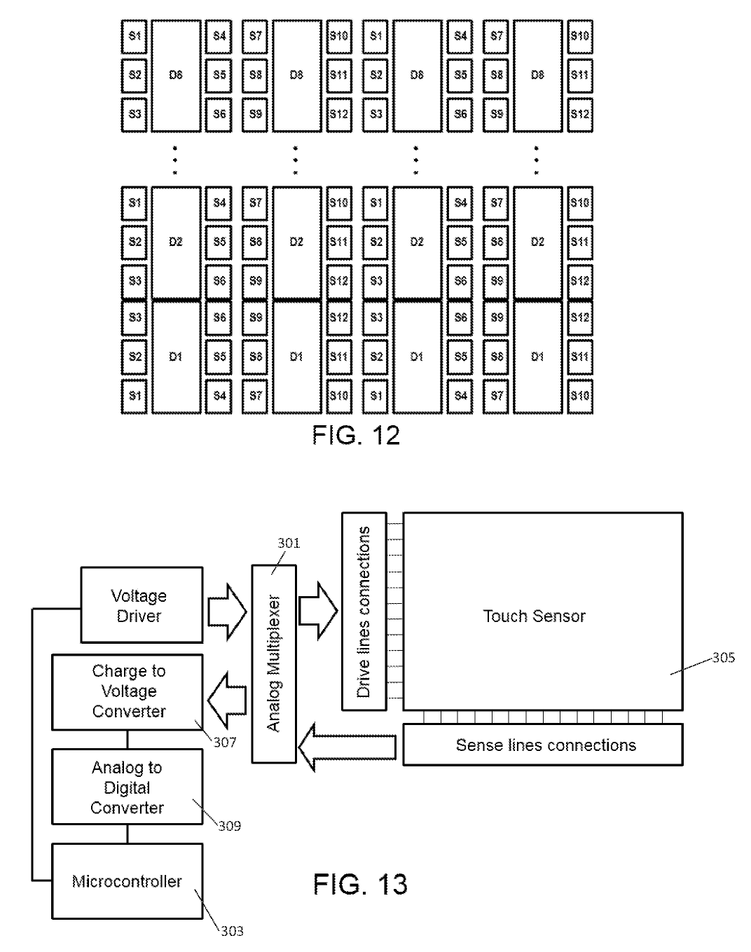

FIG. 12 illustrates how the touch sensor panel in FIG. 11 is modified in accordance with another embodiment of the present patent application. Referring to FIG. 12, counting from the left, the first column is connected to six sense channel S1 to S6. It is physically one column, but logically two columns. The second column is connected to another six sense channel from S7 to S12. It is physically the second column, but it is logically the third and the fourth columns, and so on until the last column. In this method, the number of drive lines and bonding pads for drive lines are reduced to half that required in FIG. 10.

It is noted that in this embodiment, within n adjacent columns, the drive electrodes at the same row and adjacent two columns are combined into one physical drive electrode (Dl for example).

FIG. 13 illustrates a touch sensor panel being connected to a microcontroller in accordance with an embodiment of the present patent application. Referring to FIG. 13, the rows and columns are connected to an analog multiplexor 301. The microcontroller 303 drives the touch sensor panel 305 and injects electronic charge to the drive and sense electrodes. Then, the charge is sensed by a charge to voltage converter 307. The voltage is converted to digital data by an analog to digital converter 309 and passed to the microcontroller 303 for data processing.

In the above embodiments, to reduce the number of bonding pads, the number of sense lines are increased and the number of drive lines are reduced, which increases the production yield and lowers the manufacturing cost. To enable a touch panel controller with more drive channels than sense channels to support a touch panel with more sense channels, the sense channels are reused and the electrodes are fabricated in a desired array accordingly. In some configurations, a touch controller with more drive channels than its sense channels can be interfaced with a touch panel requiring more sense channels than drive channels.

While the present patent application has been shown and described with particular references to a number of embodiments thereof, it should be noted that various other changes or modifications may be made without departing from the scope of the present invention.

What is claimed is:

1. A touch sensor panel comprising a first set and a second set of sensor elements patterned in a plurality of intersecting rows and columns, wherein:
the first set of sensor elements are configured to be drive electrodes;
the second set of sensor elements are configured to be sense electrodes;
each row comprises at least one drive electrode from the first set; and
each column comprises at least one sense electrode from the second set.

2. The touch sensor panel of claim 1, wherein the first set and a second set of sensor elements are constructed from a single patterned layer of conductive material.

3. The touch sensor panel of claim 1, wherein each row comprises only one drive electrode while each column comprises more than one sense electrode.

4. The touch sensor panel of claim 1, wherein each row comprises more than one drive electrode, each column comprises only one sense electrode, and every k adjacent columns comprise the same sense electrode, k being an integer greater than 1.

5. The touch sensor panel of claim 1, wherein each row comprises more than one drive electrode and each column comprises more than one sense electrode.

6. The touch sensor panel of claim 5, wherein every two adjacent columns comprise the same sense electrodes but different drive electrodes.

7. The touch sensor panel of claim 5, wherein every n adjacent columns comprise different sense electrodes forming a predetermined pattern, and the predetermined pattern is repeated at least once among all the columns, n being an integer greater than 1.

8. The touch sensor panel of claim 7, wherein within n adjacent columns that form the predetermined pattern, each row comprises the same drive electrode.

9. The touch sensor panel of claim 8, wherein within the n adjacent columns, the drive electrodes at the same row and adjacent two columns are combined into one physical drive electrode.

10. A method for manufacturing a touch sensor panel comprising:
patterning a first set and a second set of sensor elements in a plurality of intersecting rows and columns;
configuring the first set of sensor elements to be drive electrodes; and
configuring the second set of sensor elements to be sense electrodes; wherein:
each row comprises at least one drive electrode from the first set; and
each column comprises at least one sense electrode from the second set.

11. The method of claim 10 further comprising constructing the first set and a second set of sensor elements from a single patterned layer of conductive material.

12. The method of claim 10, wherein each row comprises only one drive electrode while each column comprises more than one sense electrode.

13. The method of claim 10, wherein each row comprises more than one drive electrode, each column comprises only one sense electrode, and every k adjacent columns comprise the same sense electrode, k being an integer greater than 1.

14. The method of claim 10, wherein each row comprises more than one drive electrode and each column comprises more than one sense electrode.

15. The method of claim 14, wherein every two adjacent columns comprise the same sense electrodes but different drive electrodes.

16. The method of claim 14, wherein every n adjacent columns comprise different sense electrodes forming a predetermined pattern, and the predetermined pattern is repeated at least once among all the columns, n being an integer greater than 1.

17. The method of claim 16, wherein within n adjacent columns that form the predetermined pattern, each row comprises the same drive electrode.

18. The method of claim 17, wherein within the n adjacent columns, the drive electrodes at the same row and adjacent two columns are combined into one physical drive electrode.

19. A touch sensor panel comprising a first set and a second set of sensor elements patterned in a plurality of intersecting rows and columns, wherein:
the first set of sensor elements are configured to be drive electrodes;
the second set of sensor elements are configured to be sense electrodes;
each row comprises more than one drive electrode from the first set;
each column comprises more than one sense electrode from the second set;
the first set and a second set of sensor elements are constructed from a single patterned layer of conductive material; and
every n adjacent columns comprise different sense electrodes forming a predetermined pattern, and the predetermined pattern is repeated at least once among all the columns, n being an integer greater than 1.

20. The touch sensor panel of claim 19, wherein within n adjacent columns that form the predetermined pattern, each row comprises the same drive electrode while the drive electrodes at the same row and adjacent two columns are combined into one physical drive electrode.
